(19) United States
(12) Patent Application Publication
(10) Pub. No.: US 2005/0079965 A1
(43) Pub. Date: Apr. 14, 2005

(54) Container forming machine

(76) Inventors: James Moshier, Reedley, CA (US); Dan Djokovic, Indianapolis, IN (US); Dan Nourian, Reedley, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 10/684,292

(22) Filed: Oct. 10, 2003

(51) Int. Cl. B31B 11/00

(52) U.S. Cl. 493/52

(57) ABSTRACT

The present invention is a space efficient container-forming machine having an optioinal pre-formation dunnage removal and staging section, an apparatus for forming the bodies of multi-sided containers from flat single-sheet paperboard blanks that assures proper alignment of the leading and trailing edges of the container blank before adhering the first and last body panels of the blank together, an apparatus for altering the path of the partially-formed container bodies while rotating the bodies themselves to a selected angle or position, and a final formation section where the bottom panels of the container are folded and adhered together. In a preferred embodiment, the alignment apparatus is located above the dunnage removal and staging section, and path of container formation inside the machine doubles back against itself in a U-turn (180 degrees), thereby reducing the overall footprint of the machine. During the U-turn, the partially-formed container is positioned for further formation activity by rotating the container itself only 90 degrees. The machine is generally designed for use with containers having more than fours sides, but may be adapted for use in forming 4-sided as well as RSC containers.

### BACKGROUND OF THE INVENTION

1. Field of the Invention

The present invention relates to machines and methods for forming containers from flat paperboard blanks, and more particularly to machines and methods for forming multi-sided containers in an optimal dimensional profile.

2. Description of the Prior Art

In the packaging industry, it has been found most efficient and otherwise effective to employ paperboard containers (“boxes” or “cases”) for the packing, shipment and storage of commodities such as fresh fruit, fresh vegetables and meat, pre-packaged goods (e.g. cans of soup, bottles of beverages, jars of jelly, bags of rice, cartons of cereal, etc. (“cartons”)) as well as a wide assortment of other products. Paperboard containers are comparatively inexpensive, light in weight, sufficiently strong for the prescribed usage and disposable at the ultimate destination.

Numerous paperboard containers and designs have been developed over the years along with machines for forming containers from such materials. These containers are typically constructed of a corrugated material which may be single face corrugated, single wall (double-faced) corrugated, double wall corrugated, triple wall corrugated, etc. Containers may also be made of other paperboard products including, without limitation, container board, boxboard, linerboard, and cardboard. Containers made from these materials can be produced in a variety of shapes and sizes suited to the specific prescribed uses intended. Such containers are unusually strong and durable for their cost and weight and thus are excellently suited to serving a multitude of uses. Typically, the manufacturers of such containers produce them in flattened, blank type configurations. These are sold in bulk to users that employ container forming machines to form, or erect, the containers for use. Such users may, for example, be companies that pack and sell, or distribute, any of the aforementioned commodities.

A conventional container-forming machine typically receives the container blanks in bulk in a hopper, or magazine. During operation, the machine feeds each blank in succession along a path of travel, applies adhesive at pre-selected locations thereon, folds the container blank along preformed score lines and into designed container configurations, compresses portions of the container so that the adhesive adheres to retain the container in the designed configuration and finally discharges the container for use in packing the commodities involved. Such packing is normally also performed on an entirely automated basis by other equipment. It is essential in such container forming machines that the containers be formed and discharged at a high rate of speed to produce the volume of containers required during the packing operation. However, it is also required that the containers, so formed, be dependably of the design configuration required and without variation from container to container so that, for example, the packing equipment is capable of handling, packing and sealing the containers. Variation in these regards from container to container may well render such containers unsatisfactory for use because such mechanized packing equipment is dependent for proper operation in numerous respects on receiving containers only of the designated design configuration and dimensions.

Many different container styles and types have been developed over the years, each being optimally suited for one or more particular products or industries. As the designs containers have advanced, the designs of container forming machines have also become increasingly more sophisticated. As a consequence, there are increasing demands and requirements of the users of such containers for the production of containers of more complex designs better suited to particular uses.

One of the uses for such containers is for holding large flexible bags filled with fluid, such as oil or syrup. The weight of such bags, when filled with fluid, is significant, calling for uniquely shaped paperboard containers to hold the bags during storage and shipping. It has been determined that a paperboard container having more than four sides provides an optimal design for holding a large fluid-filled bag. This is because pressure from the fluid inside the bag is transmitted to the walls of the container. In three-sided or four-sided containers, significant internal gaps develop inside between the edges of the fluid-filled bags and the corners of such containers. These gaps do not provide adequate support for the fluid-filled bag, especially if the container is improperly stored or stacked, that can lead to weakening and potential rupture of the bag and spillage of its contents.

Containers (“cases”) filled with products are frequently arranged in tall stacks for convenience in storage and shipping. It is therefore desirable to provide strong cases that can be arranged into tall stacks. To obtain a stronger case typically involves providing additional side or end panels, reinforced corners, and the like. These things typically increase the size, complexity and cost of the blanks used to make the cases, and the machines needed to erect them. As a result, it has become prevalent in the packaging industry to rely on the strength of the cartons or packages that are loaded into the cases to provide stacking strength for the case. For example, a case filled with 2-liter beverage bottles may well rely on the strength of the bottles loaded inside the case to provide stacking strength for the case. Stacks of such cases are in a very real sense simply stacks of the bottles upon themselves, separated by the panels of the cases.

Unfortunately, the ever increasing cost of manufacturing product cartons and packages has resulted in the use of less material in the production of cartons, packages and bottles resulting in weaker packages with thinner walls and less stacking strength. In addition, certain product packages (e.g. disposable ketchup packets) cannot be relied upon for any stacking support. Thus, it is no longer appropriate to rely on the strength of the cartons or packages that are loaded into the cases to provide stacking strength to the cases. In the fruit and commodity industries, this has never been an acceptable practice. Thus, there is a need for cases that have reliable stacking strength independent of the products or packaging loaded into them, without unduly increasing the cost or complexity of the blanks or machines used to form them.

A preferred solution is to provide a multiple-sided container (i.e., one having four or more sides, such as 4, 5, 6, 8, 10, 12, and the like) with angled corners. Containers having more than four sides are preferred for holding fluid-filled bags because their shape tends to minimize corner gaps and resist bulging, and the angled corners of such containers provide greater all-around support and stacking strength. Unfortunately, because of the complexities in forming such containers from a flat blank, many conventional machines designed to form 4-sided containers are not suitable for use in forming containers with more than four sides. In particular, folding a flat blank into a container having more than four sides presents unusual challenges in maintaining alignment of the multiple panels of the container body during formation, and in adhering the first and last of such panels together—especially if none of the corners of the container to be formed will be right angles (90 degrees).

Containers having more than four sides, such as hexagonal and octagonal containers, are preferred because the multiple body panels of such containers provide improved stacking strength, better product stability, resistance to panel bulging that may be caused by heavy product loads, more available space for graphics and advertising, and resistance to damage from stretch wrapping.

A group of container blanks known generally as regular slotted cases (RSCs) are partially pre-formed upon manufacture, and include half slotted cases (HSCs), side load RSCs, end load RSCs, RSCs with extended manufacturers joint, and the like. RSCs are generally described as container blanks in which the leading and trailing panels of the container body have already been overlapped and adhered together by the blank manufacturer before shipment. The body panels and end flaps of RSCs are pre-scored so that forming the case involves simply opening up the body, and then folding and adhering the end panels into place. Because of the overlapping of the pre-adhered panels, “flat” RSC blanks generally have three times the thickness of a single-sheet blank resulting from the two overlapping adhered panels, and the opposite side panel of the pre-formed body. However, RSC blanks are only about half as wide as a corresponding single-sheet blank used for making the same sized container. As a result, RSC blanks are about ⅓ less efficient to store and ship than corresponding single-sheet blanks used to form like containers. When hundreds of thousands of blanks are to be stored and shipped, the inefficiency of RSCs over single-sheet blanks becomes readily apparent, making it desirable to avoid the use of RSCs if possible.

A traditional method of assembling a four-sided paperboard container from a flat blank is to first crease the blank along its fold lines to form the general container shape. The two end flaps are then folded onto the two opposite corresponding side panels so that the edges of the side panels rest snugly against the flap fold line creases. This flush position ensures a sturdy and properly formed container. The end flaps are then secured to the opposite side panels using an adhesive.

Some polygonal container forming machines have been developed. U.S. Pat. Nos. 4,932,930 and 5,147,271 disclose machines that utilize a mandrel to assemble the container. The exterior shape of the mandrel corresponds to the internal shape of the container to be formed, and one or more arms are used to wrap the flat carton blank around the mandrel. These devices are not capable of rapid production of large number of containers, and require a different mandrel for each different container type to be formed. Moreover, neither device provides adequate alignment safeguards.

U.S. Pat. No. 5,375,715 discloses a device utilizing the shape of the products (i.e. bottles) inserted into the container to form the top portion of the container, in a manner similar to that of a mandrel. A series of plows and guides fold first and second sides down over the products (i.e. bottle tops). This invention requires that the products be placed into the container blank prior to the formation process which makes the device unusable in many applications, or severely limits its usefulness, such as where the products to be packaged are in a different location than the machine forming the containers, or where the products have special handling or temperature requirements that cannot be provided in conjunction with the container forming machine. This device also has an alignment shortcoming in that it relies upon the proper initial formation of the open top container, as well as the proper placement of the goods within it for proper alignment. Errors in either area will cause the subsequent creases to be made in improper locations.

It is therefore desirable to provide a machine that is capable of rapidly forming the body of a multiple-panel container from a flat blank by adhering together first and last panels of the blank while ensuring that the leading and trailing edges of the blank are properly aligned. It is also desirable to eliminate the use of a container-shaping mandrel so as to speed up the formation process, and to avoid reliance upon insertion and proper placement of the products themselves into the container as part of the container formation process.

Traditional container forming machines erect containers along a unidirectional path. A stack of flat container blanks is generally loaded onto the front end of the machine. The blanks are then individually removed from the stack, and fed into the machine. Mandrels, plows and/or actuators fold and form the blanks into containers while adhesives are applied to bond surfaces together. The containers may or may not then be loaded with goods, and the containers then exit from the opposite end of the machine. Many different container styles and types have been developed over the years, each being optimally suited for one or more particular products or industries. As the designs containers have advanced, the designs of container forming machines have also become increasingly more sophisticated. In many instances, the addition of multiple desirable features on such machines transforms the machines into large behemoths requiring considerable floor space within a warehouse or packing facility for proper operation.

U.S. Pat. No. 3,729,887 discloses one such device having three stations: a container formation station, a loading station, and a sealing station. Such a device requires significant floor space, since its length must accommodate all three stations adjacent to each other. Additional stations and processes will increase the physical dimensions of such a device.

Various machines have been developed to alter the formation or loading path of a container blank. For example, U.S. Pat. No. 5,100,369 discloses a right angle turn in the conveying means, and a means for moving containers around the turn using special fitments that are attached to the container tops as the containers travel through the machine. These fitments are engaged by corresponding fitments in the machine which carry the containers around the turn. U.S. Pat. No. 6,537,187 discloses another machine having a turning mechanism utilizing a rotatable distributor disk, a primary conveying means, pulleys, and a secondary conveyor. Critical timing and interaction between these components is required for the container to properly make the turn.

Unfortunately, neither of these machines effectively utilizes its floor space. Although the right angle turn in the '369 device decreases its overall length, such a decrease is accompanied by an increased width. This actually results in a greater floor space requirement, since the empty rectangular floor space partially bounded by the conveying means has limited uses. Specifically, usage of such empty space is limited by safety concerns, the need for routine service of, and access to, the device, and the availability of other devices that would fit within the empty space. The '187 invention also fails to effectively utilize its floor space, in that a significant portion of the central area bounded by the conveying means is occupied by the components necessary to effect the turn and rotation of the containers. The remaining unused floor space is not easily accessible from outside the bounded conveying means, and is therefore wasted. Furthermore, neither device provides both a simple and universal means for affecting the container rotation itself. The '369 invention functions only when used with containers having irregularly-shaped or angled fitments. An alternatively shaped fitment shape would prevent the container from rotating while being grasped by machine, and using symmetrical or circular fitments would creating a risk that the containers would not be properly rotated during the turn. Moreover, the '369 invention permits only a ninety degree counterclockwise rotation in the container facing—there is no means for adjusting the amount of rotation, or to prevent the container from rotating at all. The '187 invention requires precise timing between the interaction of a central distributor disk, pulleys and a secondary conveyor belt to perform the turn, complicating the operation of the invention and increasing maintenance times and expenses.

It is therefore desirable to provide a container forming machine that is capable of performing a variety of formation, loading and/or sealing operations on a container blank having minimal physical dimensions (a minimal footprint), so as to permit the performance of such operations in locations having little available floor space. It is also desirable to provide a machine that minimizes wasted floor space by making full and efficient use of the floor space utilized by the operable machine components or stations. It is also desirable to provide a machine having simple, universal and adjustable means for rotating and positioning containers during the formation process.

### SUMMARY OF THE INVENTION

The present invention is a space efficient container-forming machine having an optional pre-formation dunnage removal and staging section, an apparatus for forming the bodies of multi-sided containers from flat single-sheet paperboard blanks that assures proper alignment of the leading and trailing edges of the container blank before adhering the first and last body panels of the blank together, an apparatus for altering the path of the partially-formed container bodies while rotating the bodies themselves to a selected angle or position, and a final formation section where the bottom panels of the container are folded and adhered together. In a preferred embodiment, the alignment apparatus is located above the dunnage removal and staging section, and path of container formation inside the machine doubles back against itself in a U-turn (180 degrees), thereby reducing the overall footprint of the machine. During the U-turn, the partially-formed container is positioned for further formation activity by rotating the container itself only 90 degrees. The machine is generally designed for use with containers having more than fours sides, but may be adapted for use in forming 4-sided as well as RSC containers.

The present invention generally comprises methods for forming containers and a machine comprising the following systems: (1) an optional dunnage removal apparatus that removes the lowermost dunnage or slip sheet from a stack of container blanks while conveying the remaining blanks of the stack into the machine; (2) an optional set of positioning conveyors and lift for moving and raising the stack of container blanks such that the uppermost blank may be removed from the stack and fed into the machine; (3) an initial forming section comprising a plurality of various plows and guides disposed along a lateral track defined by one or more conveyor belts along which a pre-scored container blank is taken, the plows and guides being situated in specific locations along the track to form the various panels of the container blank by folding it along the pre-scored lines; (4) an alignment and adhesion system that initially separates the first and last panels of the blank while they are aligned and thereafter attaches them together; (5) an internal turning system that allows the path of formation to preferably double back against itself to minimize the overall footprint of the machine, while at the same time rotating the partially-formed container to a desired angle, preferably 90 degrees; (6) a laterally operable mandrel system with associated folding elements for forming and sealing the bottom portion of the container; and (7) an output system.

A stack of pre-scored flat container blanks resting on a dunnage sheet is conveyed forward into the machine on one or more floor level conveyors. The leading edge of the dunnage sheet is fed into a set of rollers that pinch together and pull the dunnage sheet between them as they rotate. This pulls the sheet forward through the rollers after which it is guided downward and away from the machine, preferably back against itself into a discard area below the floor level conveyors. This action pulls the stack of container blanks forward onto another conveyor which positions the stack at a lift. The stack of blanks is then raised by the lift such that the uppermost blank may be removed from the stack and fed into the machine.

Each blank is fed into the machine by a primary conveyor, and a series of guides and plows bend and fold the panels along the pre-scored lines such that they are wrapped around or “funneled” in a circular fashion to form the body of the container. The forming apparatus may be easily configured to handle blanks having any of a wide range of different numbers of panels, such that containers with virtually any number of panels (sides) may be formed. Eventually, the circular wrapping causes the last panel of the blank to come into the proximity of the first panel. Then, as described more fully hereinbelow, these two panels are adhered together to form the container body. However, before such adhesion takes place, special devices are employed to assure that all of the panels of the container are in alignment. This is because the friction between the panels of the blank and the various plows and guides may cause some of the panels to lag behind others. A unique apparatus is used to line up yet maintain separation between the first and last panels upon which adhesive has been applied while the alignment takes place. Once alignment is accomplished, the panels are pressed together and bonded by the adhesive.

One or more continuous primary conveyors are provided along the path to carry blank after blank through the initial formation section of the machine where they encounter various guides and plows that perform several folds on each container blank. These primary conveyors may be provided in any appropriate form such as one or more continuous pinch belts with rollers, one or more continuous chains or belts with cleats adjustably attached thereto, or the like. Each of the primary conveyors moves at the same speed, and if cleats are used, they are deployed at regular and synchronous intervals according to the size and shape of the particular container blanks being used.

After the initial folds have been accomplished, the primary conveyors may continue moving the partially-folded container blanks forward, or may hand off the blanks to a set of one or more secondary conveyors. Alignment of the body panels takes place first, followed by adhesion of the first and last panels to form a wrap. A separation bar is provided along the path of formation, and the first and last panels of the container blank are guided into positions above and below this bar. One or more adhesive applicators are provided near the separation bar to spray or otherwise apply adhesive onto the first or last panel (or both) of the container blank after it has passed through the majority of the plows and guides, but before alignment or bonding has taken place. If used, the secondary conveyors may be provided in any appropriate form such as one or more continuous chains with cleats adjustably attached thereto, one or more continuous belts with cleats adjustably attached thereto, or the like. The secondary conveyors take over movement of the blank from the primary conveyors. Then a unique alignment apparatus is used to “catch up” the trailing edges of the container blank panels bringing them into alignment as the blank continues through the machine. Once alignment is accomplished, the separation bar terminates and the first and last panels are pressed together and bonded by the adhesive.

The partially-formed container then enters an apparatus to make a turn inside the machine, preferably 180 degrees. A support arm is positioned to meet the partially-formed container body, the arm having one or more vacuum suction cups facing outward. Vacuum suction is applied to the partially formed container as it contacts the suction cups so that they grasp the container. The support arm then begins to travel around a curved perimeter of a base plate. The amount and length of this turn is dictated by the path of the support arm around the base plate, which is determined by the size and curvature of the base plate. Such a path may be only a few degrees for a small turn, or a full 180 degrees for the preferred U-turn.

During the turn around the base plate, the container may or may not be rotated. It is to be appreciated that if the support arm holding the container simply travels around the turn without independent rotation, the front face of the container will be turned the same amount as the turn itself. For example, in a 90 degree clockwise turn, the front of a container that was facing south now faces west. However, the position of the container may be changed by rotating the end of the support arm along its y-axis. Thus, if the end of the support arm is rotated at a speed that is equal to, but opposite from, that of the support arm itself around the base plate, the front of the container will continue to face in the same direction throughout the turn. In such a case, for example, in a 90 degree clockwise turn, the front of the container that started the turn facing south still faces south after the turn is completed. If, on the other hand, the end of the support arm is rotated faster than the arm itself travels around the base plate, the front of the container may be turned more than the overall turn. Likewise, if the end of the support arm is rotated slower than the arm itself travels around the base plate, the front of the container may be turned less than the overall turn. The difference between the rotation speed and the speed around the base plate governs the extent of the change. Such a change may be as little as a few degrees, to as much as 360 degrees. When the container arrives at the end of the turn, the vacuum suction is discontinued, releasing the container and allowing it to travel onward for further processing.

The turning apparatus generally comprises of a horizontal base plate with rounded edges supporting a plurality of outwardly extending rotatable support arms, and a motorized mechanism for driving the support arms around the perimeter of the base plate. Each support arm has an end that includes a head supporting one or more suction cups. The suction cups are connected to a switchable vacuum source, which permits the suction cups to securely grasp a surface of a container upon contact when the vacuum is activated, and release it when the vacuum is discontinued. The support arms are also independently rotatable around their y-axes. This permits the suction cups to fully grasp the container and maintain this grasp while the container travels around a turn. This also permits the invention to rotate the front face of the container in any number of degrees, simply by rotating the support arm at a different speed relative to the speed and direction of the overall turn.

It is to be appreciated that any turn angle in the path through the machine may be accommodated simply by altering the length of the turn, the rotation speed of the support arms and/or the release timing of the suction cups. This permits a turn angle of anywhere from a few degrees to 180 degrees. It is also to be appreciated that the container rotation itself may be adjusted simply by limiting rotation or modifying the rotation speed of the support arms relative to the turn or turn speed of the turn conveyor.

Accordingly, it is possible (and preferred) to use the turning apparatus to minimize the floor space requirements of any container assembly device by providing a 180 degree turn in the path of assembly. A 180 degree turn provides the greatest potential reduction in the physical dimension of the overall machine, in that instead of a single lengthy straight path of formation, the path doubles back against itself making for a more compact machine. The floor space requirements may be further optimized using several 180 degree turns within the same conveying means. Finally, the use of a single base plate with multiple rotatable support arms provides improved throughput as well as a simple and effective alternative to earlier inventions. It is also preferred to rotate the partially-formed container blank only 90 degrees while it makes the 180 degree turn. This allows an open end of the partially-formed container blank to be positioned for lateral insertion of a moving mandrel during the final formation processes which forms the bottom portion of the container.

A plurality of laterally disposed mandrels are provided in the final formation section of the machine which are movably attached to and rotate around a continuous track. A section of this track travels in parallel with the formation path of the container blanks. In this section, the mandrels are extended laterally in sequence with the partially-formed container blanks such that the next mandrel in sequence is temporarily inserted into the next partially-formed container blank passing through this section of the machine. While the mandrel is inserted into the partially-formed container blank, a set of plows and folding elements working in conjunction with adhesive applicators fold and adhere a set of panels on the container blank to form the bottom of the container. The mandrel is then withdrawn, and travels around the track to be positioned for insertion into another container blank in sequence. Each of the mandrels on the track performs these same steps with successive container blanks. Following removal of the mandrel, the now-formed containers are then conveyed away from the machine.

Accordingly, the present invention provides a space-efficient machine that is capable of performing the necessary steps to rapidly form multiple-sided containers having minimal alignment defects. The unique system saves space through the use of the unique internal turning apparatus which changes the path of formation, and by providing the stack staging area below the initial formation and alignment section of the machine. The unique alignment section assures that the container side panels and back edges are in alignment before applying pressure to bond the adhesive. Unlike the prior art disclosed above, such alignment is not dependent upon the proper initial placement of the carton underneath a mandrel or analogous component, or upon the proper placement of goods within the container. The turning apparatus is capable of rotating and opening the partially-formed container blanks in any appropriate position for further processing, which is accomplished by the insertable mandrels in the final forming section.

It is therefore a primary object of the present invention to provide a machine having a minimal overall footprint that is capable of rapidly forming multiple-panel containers from flat blanks having an optional dunnage removal and staging section located below a section for adhering together first and last panels of the blank, after ensuring that the leading and trailing edges of the blank are properly aligned, followed by a section that turns and rotates the partially formed container before it enters a final section where container formation is completed.

It is also a primary object of the present invention to provide a container-forming machine in which the path of container formation turns so as to minimize the physical dimensions of the overall machine so as to permit the formation of multiple-panel containers in locations having minimal available floor space.

It is another primary object of the present invention to provide a machine for rapidly forming multiple-panel containers from flat or single-sheet blanks having a dunnage system for removal of unwanted slip sheets from stacks of container blanks, a system for aligning the first and last panels of the blank before these panels are adhered together, another system that alters the path of container formation so as to minimize the physical dimensions of the overall machine permitting use of the machine in locations having minimal available floor space, and a final container formation section following the altered path.

It is also an important object of the present invention to provide a machine that is capable of rapidly forming multiple-panel containers from flat blanks that avoids reliance upon insertion and proper placement of the products themselves into the container as part of the container formation process.

It is also an important object of the present invention to provide a means for assembling containers that ensures that the edges of the container are aligned properly prior to adhesion of the first and last panels of the body of the container, thereby reducing the number of potentially defective containers.

It is also an important object of the present invention to provide an apparatus for use in a container-forming machine that alters the path of container formation while simultaneously rotating the containers being formed to a desired position.

It is a further object of the present invention to provide an apparatus for turning the path of formation in a container-forming machine that minimizes unused floor space by making full and efficient use of the floor space bounded within the container conveying means.

It is also an object of the present invention to provide an apparatus for changing the path of formation in a container forming machine which is relatively simple to implement, adjust and maintain.

It is also an object of the present invention to reduce material costs and improve freight economy by providing a machine for rapidly forming multiple-panel containers from flat or single-sheet blanks or from RSC blanks.

It is also an object of the present invention to provide a machine for rapidly forming multiple-panel containers having improved stacking strength, better product stability, resistance to panel bulging that may be caused by heavy product loads, more available space for graphics and advertising, an optional display window, and resistance to damage from stretch wrapping.

Additional objects of the invention will be apparent from the detailed description and the claims herein.

### BRIEF DESCRIPTION OF THE DRAWINGS

FIG. 1 is a left side perspective top view of an exemplary forming apparatus used with the present invention, depicting a container blank passing through alignment, adhesion and formation processes.

FIG. 2 is a right side perspective top view of the apparatus shown in FIG. 1.

FIG. 3 is an enlarged perspective view of an embodiment of an alignment and adhesion apparatus.

FIG. 4 is a left side perspective view of a container formation path and apparatus showing a blank passing through formation, alignment and adhesion processes.

FIG. 5 is a set of sequences of views of a container blank showing its initial formation stages from perspective, top and end views.

FIG. 6 is a set of sequences of views of a container blank showing additional formation stages from perspective, top and end views.

FIG. 7 is perspective view of a container formation path and apparatus showing formation, alignment and adhesion processes.

FIG. 8 is a perspective top view of an embodiment of the turning apparatus of the present invention.

FIG. 9 is a perspective bottom view of the embodiment of FIG. 8.

FIG. 10 is a top plan view of the embodiment of FIG. 8.

FIG. 11 is a perspective view of a dunnage removal apparatus.

FIG. 12 is a top plan view of the overall machine of the present invention.

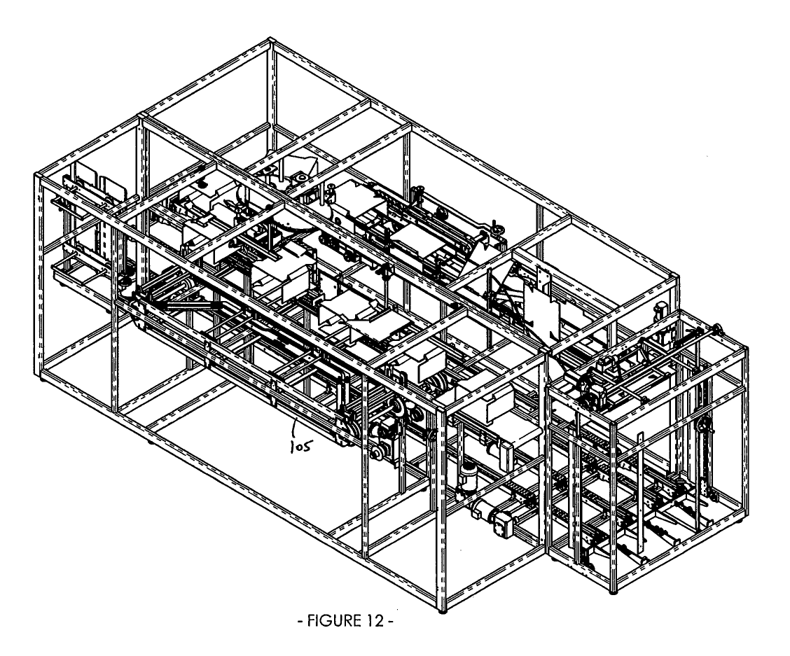

FIG. 13 is a perspective side view of the overall machine of the present invention.

FIG. 14 is a view of a representative container containing products.

### DETAILED DESCRIPTION

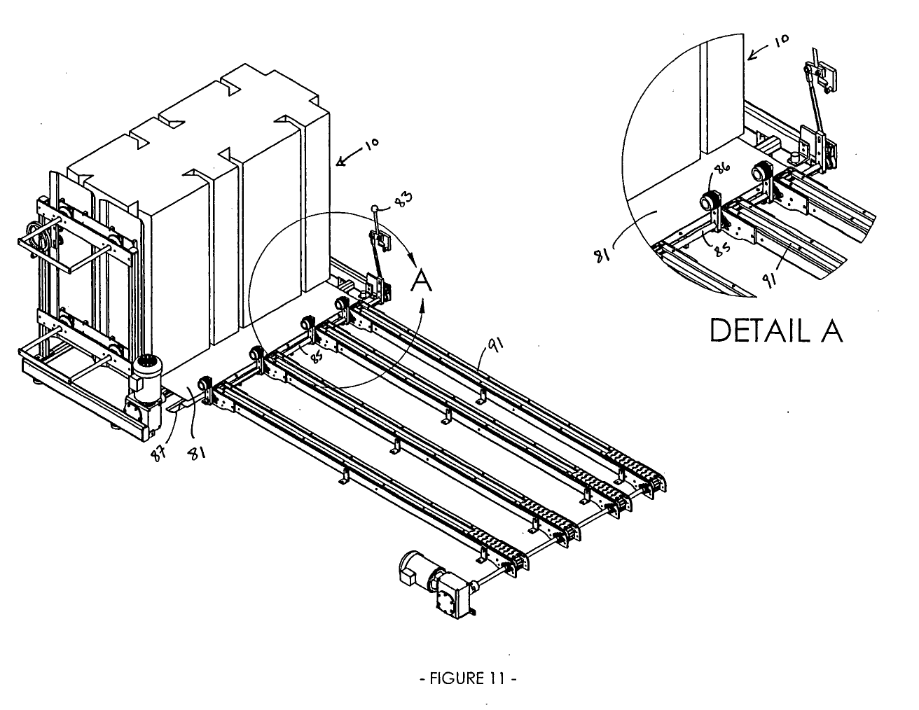

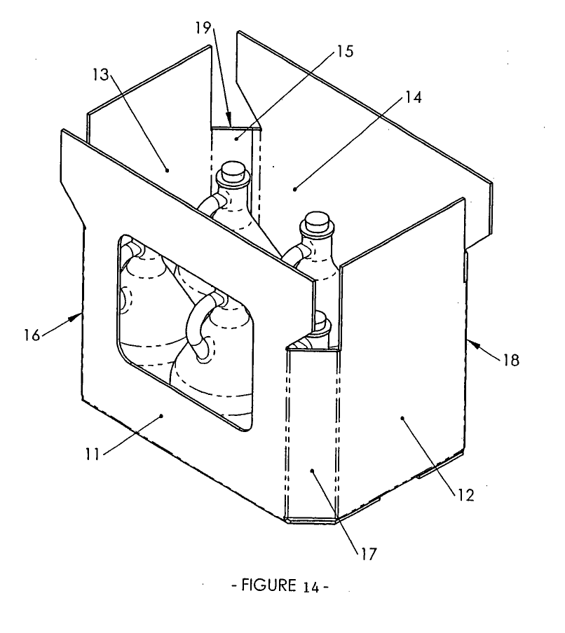

Referring to the drawings wherein like reference characters designate like or corresponding parts throughout the several views, and referring particularly to FIGS. 11 and 13-14, it is seen that the first optional section of the machine is an apparatus for removal of a lower dunnage sheet 81 from the bottom of a stack of container blanks 10. A set of upper rollers 86 are attached to a rotatable bar 85. A set of corresponding lower rollers 88 (not shown) are provided below rollers 86 for engagement therewith. Rollers 86 and 88 are provided with teeth, grippers or other frictional surfaces for engaging dunnage sheets 81. Operation of a lever 83 imparts rotation to bar 85 pulling rollers 86 away from lower rollers 88. Dunnage sheet 81 is then inserted between rollers 86 and 88 as shown in FIG. 11. The operation of lever 83 is then reversed causing rollers 86 to close against dunnage sheet 81, pinching sheet 81 between rollers 86 and 88, and bending the leading edge of sheet 81 downward. Lower rollers 88 are then activated which pulls dunnage sheet 81 down and through rollers 86, 88 where it encounters lower deflection panel 87 which guides sheet 81 back and away from the machine.

The removal of dunnage sheet 81 in the fashion described above also causes the remaining stack of container blanks 10 to move forward onto a plurality of conveyors 91 which carry the stack to a lifting area 95. The stack of blanks 10 is lifted upward in area 95 so that the uppermost blank 10 may then be removed from the top of the stack and fed into a set of primary conveyors 22 in a conventional manner.

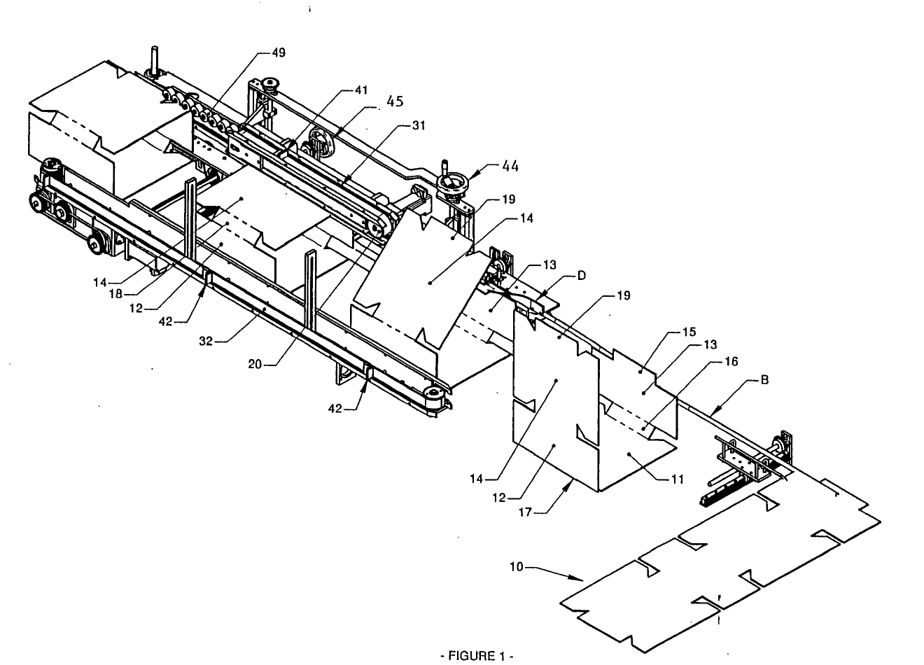

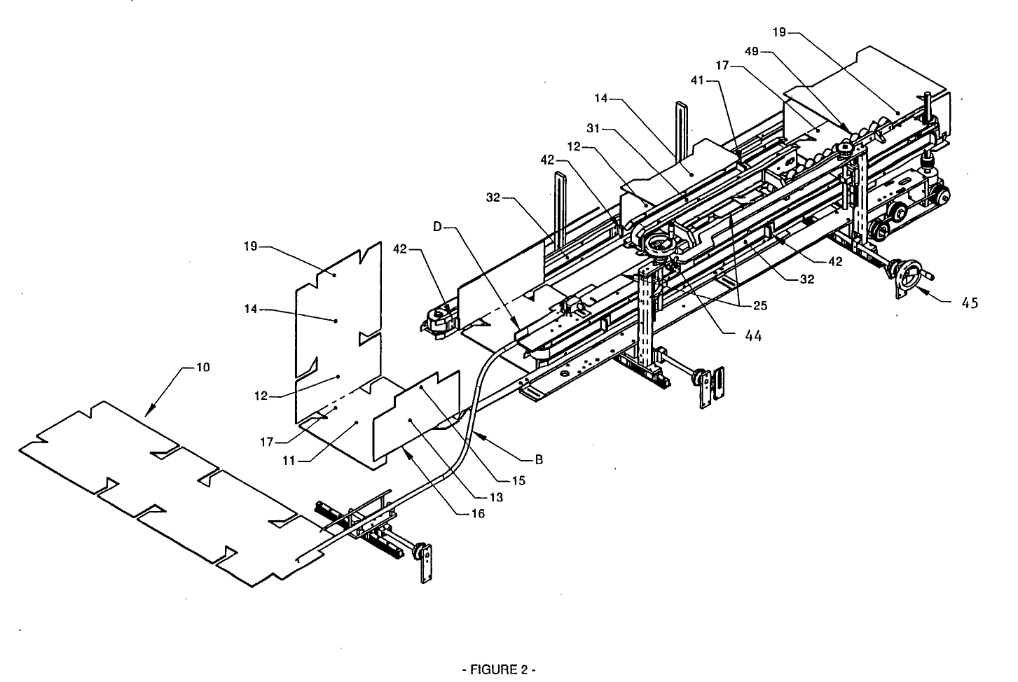

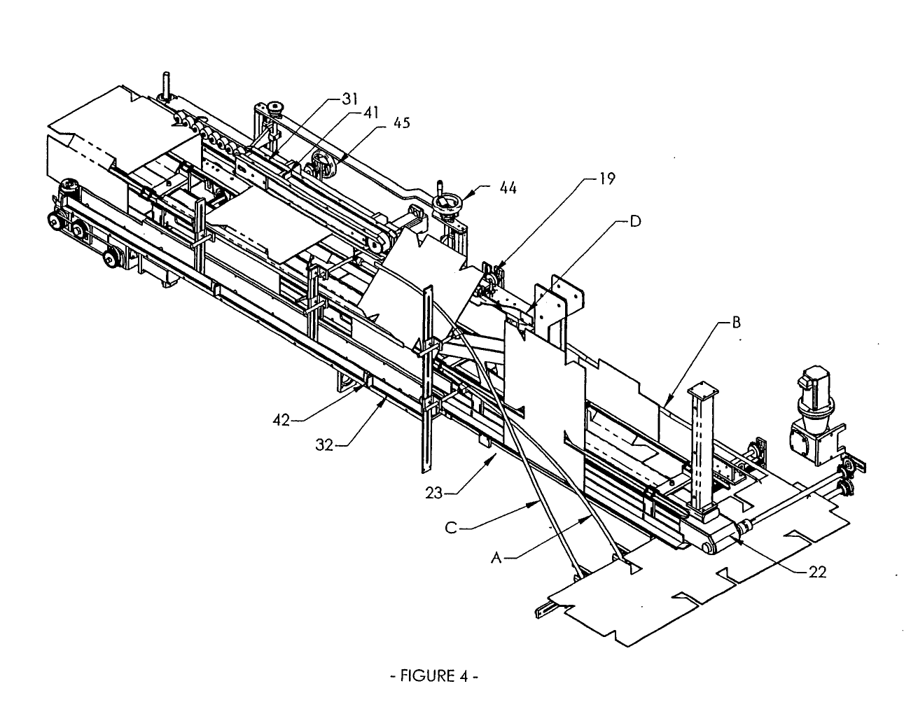

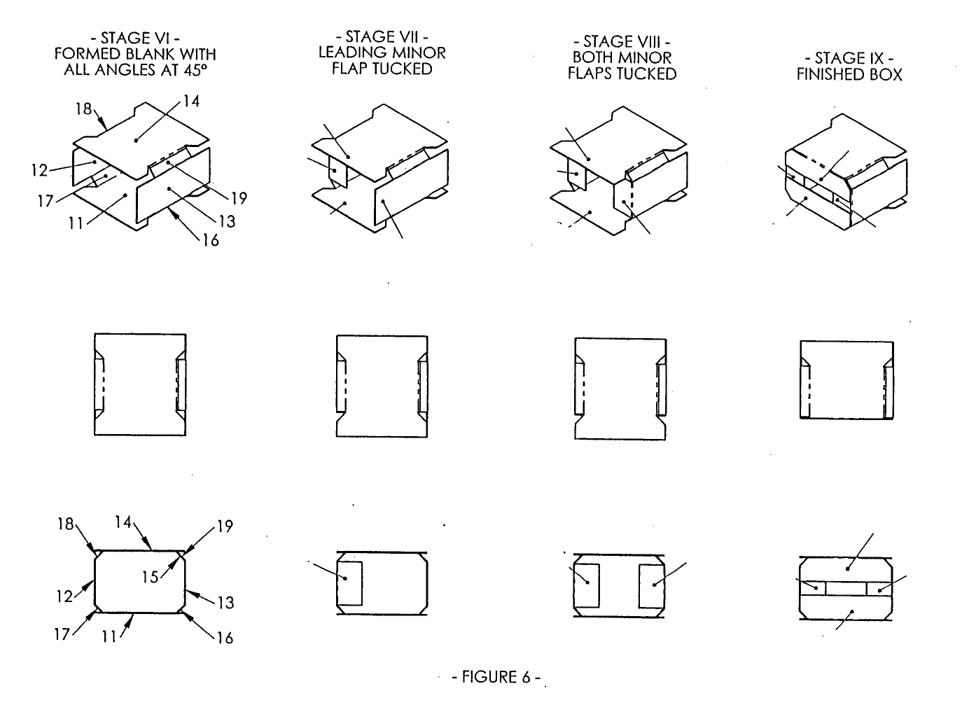

Turning to the formation apparatus illustrated in FIG. 4, a series of plows and guides (A-D) are provided which bend, fold and wrap the plurality of panels of a container blank 10 to form the body of a container as the blank 10 is fed laterally through a forming machine. It is to be appreciated that the blank 10 illustrated in FIGS. 1-2 and 4-6 has eight panels such that it forms an octagonal container body, but that a blank 10 having any number of panels (e.g., 4-12, or more) could also be formed in a similar manner with minor adjustments to the plows and guides of the machine.

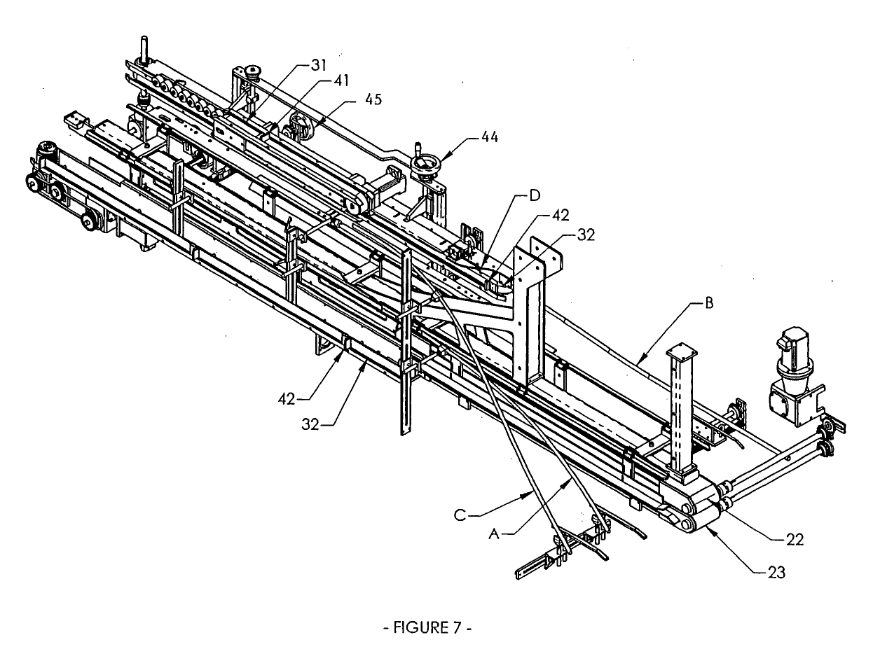

In the example illustrated in FIG. 4, blank 10 is urged forward laterally through the machine by the primary conveyors 22. The exemplary embodiment of FIGS. 4 and 7 illustrates primary conveyors 22 as a pair of pinch belts 22 and 23, however it is to be appreciated that any appropriate conveyance means may be used including without limitation, belts or chains having adjustably removable cleats located at appropriate intervals thereon. Pinch belts are preferred over cleats as the primary conveyors 22 because pinch belts avoid damaging the blank as it encounters frictional resistance from the forming plows and guides. Such frictional resistance could cause cleats to impart dents or deformities to the blank, whereas pinch belts allow some slippage of the blank 10 without damaging it, while maintaining throughput of blanks through the machine. This slippage is compensated for in an alignment section described more fully below. As it is moved through the machine, the container blank 10 encounters a series of inner and outer plows and guides (A-D) which bend, fold and wrap the various panels of the blank in a circular or funnel fashion.

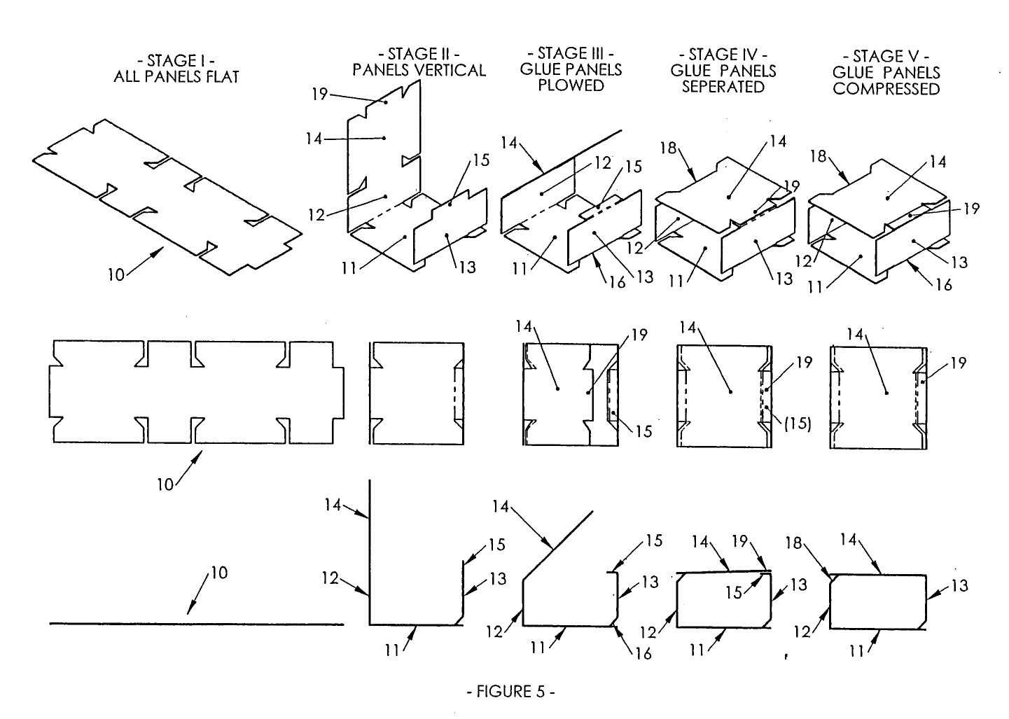

The various stages of folding experienced by this exemplary blank are illustrated in FIG. 5. First, side panel 12 including attached top panel 14 is initially bent upward to a generally vertical position by side plow bar A. At about the same time, second side panel 13 is also bent into a generally vertical position by side plow bar B. See FIG. 4, and Stage II of FIG. 5. Next, plow bar C folds top panel 14 down to an angled position. See FIG. 4. At about the same time, an intermediate end panel 15 attached to side panel 13 is bent from vertical to horizontal by plow bar D. These two folds are shown at Stage III of FIG. 5. These major folds are preferably accomplished while blank 10 is being propelled only by the primary pinch belt conveyors 22 so as to avoid any potential damage to blank 10 that may result from cleats pressing against blank 10 during the frictional resistance imparted by plows A-D.

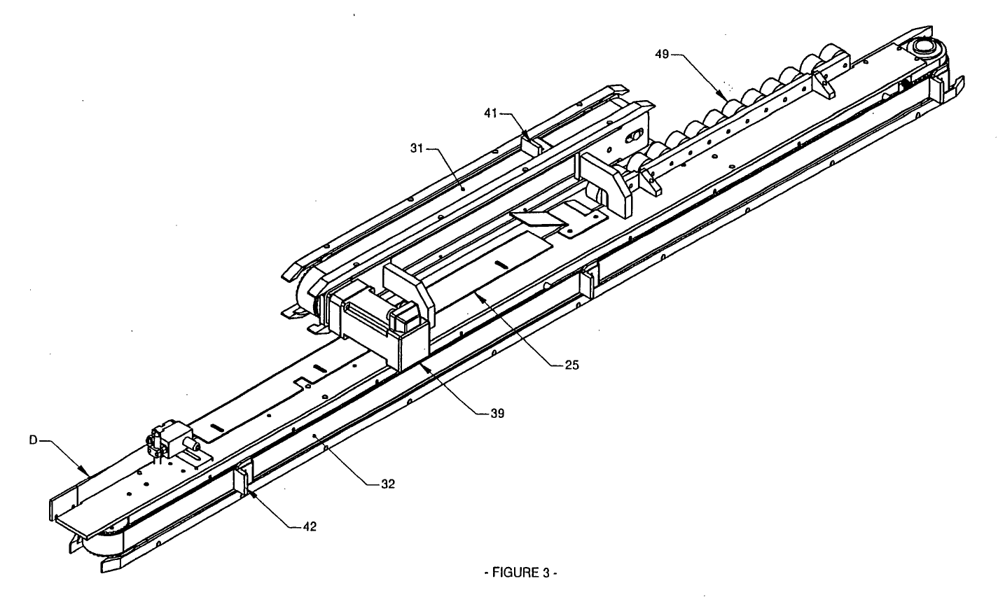

In the illustrated embodiment, as blank 10 continues moving forward it is handed off to a set of one or more secondary conveyors 32. In the exemplary embodiment illustrated in FIGS. 1-4 and 7, it is seen that these secondary conveyors 32 are provided on either side of the path of the blank 10 defined by the primary conveyors 22. Secondary conveyors 32 are provided with adjustably positionable cleats 42 for engagement with the now up-folded side panels 12 and 13 of blank 10. The positions of cleats 42 on conveyors 32 may be adjusted according to the size, spacing and style of the particular container blanks 10 introduced into the machine. If multiple secondary conveyors 32 are used, each of cleats 42 is synchronized on its respective conveyor 32 so that each cleat 42 engages the back edge of its respective panel on the same plane so as to maintain all of panels 11-13 in alignment with each other.

Top panel 14 (with attached intermediate panel 19) is next folded to a generally horizontal position as shown at Stage IV of FIG. 5. This activity results in the position of intermediate panel 19 attached to top panel 14 being located in a spaced relationship above intermediate end panel 15 of panel 13. These two intermediate panels (19 and 15) will eventually be adhered together to form a continuous body or wrap of the formed container. It is to be appreciated that blank 10 may have any number of panels (in the illustrated example, there are eight such panels), and that plows and guides may be added, removed and/or adjusted according to the given number of panels so that the first and last panels (in the illustrated example, intermediate panels 15 and 19) are positioned above each other in a spaced relationship prior to adhesion. It is also to be appreciated that the primary and secondary conveyors, and any cleats located thereon, may also be adjusted according to the size, style and spacing of the particular container blanks 10 introduced into the machine.

Between stages I-IV, the friction between plow bars A, B, C and D against respective panels 12, 13, 14 and 15 may cause panels 14 and 19 to drag slightly such that they lag behind side panels 12 and 13 which are being propelled forward by cleats 42 on secondary side conveyors 32. The larger the container blank, the larger the panels, the greater the surface area and distance from the first panel to the last panel, and the more pronounced the potential frictional lag of the most remote panels (e.g. 14 and 19) from the panels closest (e.g. 12 and 13) to the conveyors 22 and 32. For some container blanks, this lag may be as much as two inches. Because of this friction, it is important to assure that main panels 11-14, and particularly the intermediate panels 15 & 19 are properly aligned before they are adhered to each other. The position of panel 11 is not of concern in the illustrated embodiment since it is located between panels 12 and 13 which are being moved synchronously by aligned cleats 42 on secondary conveyors 32. However, this may not necessarily be the case in a different embodiment with different conveyors contacting different panels.

The adhesion and alignment is accomplished by first applying longitudinal beads or strips of adhesive to the top of lower panel 15 (or the bottom of upper panel 19, or both) while keeping lower panel 15 spatially separated from upper panel 19 until alignment occurs. This separation is accomplished using a separating member 25 positioned between panels 15 and 19 that extends for a short distance along the path through the machine, after plow D has bent panel 14 down. Over this critical span that includes but extends beyond member 25, one or more additional alignment devices 31 are provided to engage the trailing edge(s) of one or more of the now bent panels (e.g. 12, 13 and/or 14 in the illustrated embodiment) of blank 10 to bring them into alignment with the back edge of the remaining panels (e.g. bottom panel 11).

In the illustrated embodiment, one or more alignment conveyors 31 are provided along the critical span of the longitudinal path of the container blank 10 through the machine including and extending beyond separating member 25. Each alignment conveyor 31 is a continuous motor-operated belt that is provided with a plurality of adjustably positionable cleats 41 located thereon at spaced intervals. These intervals may be the same or different from those of cleats 42 on secondary conveyors 32. In the illustrated embodiment, alignment conveyor 31 is mounted above the path of the container blank so that each cleat 41 engages the trailing edge of a top panel 14. Additional conveyors 31 may also be provided along the same critical section of the longitudinal path, each additional alignment conveyor 31 having, respectively, a plurality of cleats 41 located thereon at the same spaced intervals. It is to be appreciated that one or more alignment conveyors 32 may be provided at any suitable location along the path of blank 10 in order to engage any panels of the blank 10 that may potentially be trailing as a result of frictional resistance discussed above.

Each alignment conveyor 31 is independently operable from the primary 22 and, if used, secondary conveyors 32. When multiple alignment conveyors 31 are used, they are synchronized with each other. Alignment conveyors 31 do not always operate at the same speed as primary and secondary conveyors 22 and 32. In the illustrated embodiment, a single alignment conveyor 31 is provided in a preferred location above the path of container blank 10. After blank 10 has been folded as described in stage IV, after adhesive has been applied, and while panels 15 and 19 are being held apart by member 25, the alignment conveyor(s) 31 come into use.

Alignment conveyors 31 pause briefly while the trailing edges of panels 12 and 13 are moved forward by secondary conveyors 32 to a position where those trailing edges (and cleats 42) have moved a short distance past the beginnings of the alignment conveyors 31. This delay is provided to compensate for the possible lag of panel 14 caused by the frictional resistance described previously, and allows potentially lagging panel 14 to also move past the beginnings of the alignment conveyors 31. Once this position is reached (i.e., cleats 42 have traveled a short distance past the beginnings of alignment conveyors 31), alignment conveyors 31 are activated and initially move more quickly than primary and secondary conveyors 22 and 32 in order to “catch up” with them. Servo or other similar motors may be used to accomplish this movement. This quick movement causes cleat(s) 41 to engage the trailing edge(s) of any potentially lagging panel(s) (e.g., panel 14) and bring them into alignment with the remaining panels of the blank 10. Once alignment cleats 41 have caught up with and are in alignment with secondary conveyor cleats 42, the lagging panel(s) are in alignment with the other major panels of the blank 10, and the speed of alignment conveyors 31 is reduced to match that of secondary conveyors 32. In the illustrated embodiment, panels 15 and 19 are now directly above/below each other.

Once alignment has been achieved, panels 15 and 19 move forward past the termination of separation member 25, and encounter a compression mechanism on the path. This compression mechanism may take any appropriate form (such as rollers 49 in the illustrated embodiment) which compresses intermediate panel 19 against intermediate panel 15 so that the adhesive between these panels joins them firmly together. This adhesion does not occur until all major panels of the container blank are in alignment, transforming the container blank into a large open sleeve or wrap made up of multiple adjoining panels.

In the illustrated embodiment, first and last panels 15 and 19 are maintained in a parallel, generally horizontal position during the alignment and compression operations so as to assure proper and complete adhesion. However, the machine may be set up such that the first and last panels are maintained in some other position (vertical, angled, etc.) during alignment and compression operations, so long as they are parallel to each other. After adhesion, and during later formation processes these panels may then be bent at any appropriate angle.

The positions of alignment conveyors 31 and pressure rollers 49 are adjustable so as to accommodate different sized container blanks 10. In the illustrated embodiment, the carriage assembly supporting conveyor 31 and rollers 49 may be adjusted upward or downward by rotating adjustment screw 44, and it may be rotated forward or backward using adjustment screw 45. The amount of adjustment will depend upon the size and shape of the container blank 10 to be used.

It is important to recognize that there is a critical point along the formation path through the machine at and after which the one or more alignment devices 31 should make contact with panels of the container blank 10. The major folds of the container blank 10 must be accomplished before this point, and sufficient space allowed for any lagging panels to also pass the point before alignment devices 31 are activated. Alignment devices 31 must first wait until all of the panels of blank 10, including any that may lag behind because of the friction of the formation process, have moved beyond the crucial point. This generally means waiting longer than the time necessary for the panels immediately adjacent to the secondary conveyors 32 to reach the critical point, the amount of delay (space) depending upon the size and shape of the particular container. The remote panels of larger container blanks with larger panels and more surface area (i.e., generating more frictional resistance) are likely to have a more pronounced lag than those of smaller containers with smaller panels and less surface area. When sufficient time or movement has occurred to assure that all panels have passed the crucial point, the alignment devices 31 are activated and quickly “catch up” with the secondary conveyors 32, and in the process they bring the lagging panels of the container blank 10 into alignment with the other panels of the blank.

It is to be appreciated that the “catch up” process of the alignment conveyors may be accomplished using a variety of different devices, and that one or more of such devices may be deployed at any suitable position or location along the path of formation, including without limitation, above, below, at one or more corners, or along one or more sides of said path. In one alternative embodiment, one or more pneumatic or hydraulic cylinders may be utilized in conjunction with one or more conveyors. In this embodiment, once all panels of the blank 10 have passed the critical point, the cylinder is activated which causes an associated contact element to be quickly extended out in parallel with the path of blank 10 such that the element pushes against a frictionally trailing panel of the blank 10. This movement causes the trailing panel to catch up with the remaining panels of the blank, at which point an additional conveyor engages this panel to keep it in alignment.

The “catch up” alignment device may alternatively take the form of one of numerous other embodiments that cause the necessary lurch which brings the remote panel into phase/alignment with the remaining panels, such as: a timing belt, a pulsing servo motor attached to a conveyor, a powered wheel and rail system, pinch belts, bottom rollers with tabs, adjustably cleated chains or belts (as illustrated), suction cups along the path, a drum system, or the like.

Once the container blank 10 has been folded around itself with the overlapping panels adhered to each other, further activity is required before the container is completely formed. If this activity were to continue along a straight path, that path would be lengthy, resulting in an elongated formation machine. Such a large machine would require considerable floor space that may not always be available. Accordingly, in order to reduce the size of the footprint of the machine, the container formation path inside the machine makes a 180 degree turn before formation continues. This internal U-turn allows the overall machine to be more compact, making it possible to fit into a smaller space. It is to be appreciated that while the following discussion refers to a 180 degree turn, a turn of any number of degrees (from 1 to 360) may be accomplished using the apparatus of the present invention.

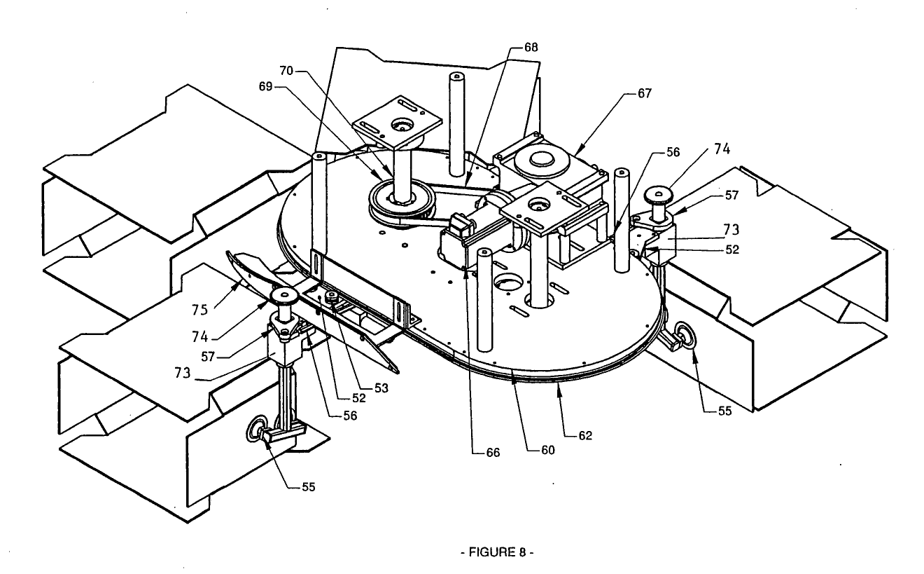

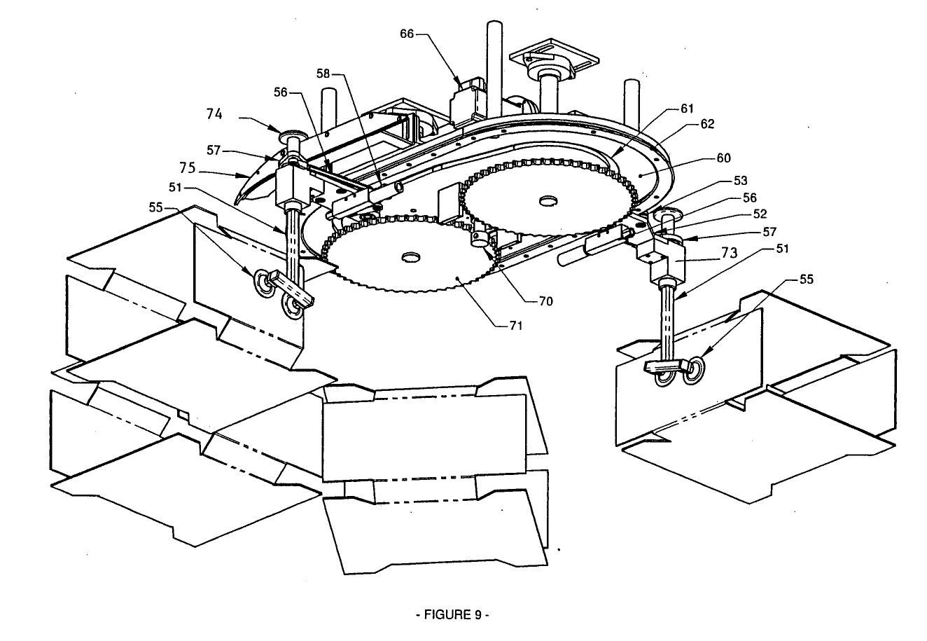

Referring to FIGS. 8-10, in the illustrated embodiment a U-turn may be accomplished through the use of a plurality of outwardly extending moveable support structures 52, each structure 52 supporting a pivotally mounted rotatable arm 51 which, in turn, supports one or more vacuum suction cups 55 for temporary engagement with a panel (e.g., 12) of each container blank 10. Arm support structures 52 are provided at spaced intervals on a track 62 located on the underside of a base plate 60 around which the turn (in this case, a U-turn) is made. The spacing of structures 52 is adjustable according to the size of the container blanks 10 and the frequency of their arrival. Base plate 60 and track 62 may have a circular, oval, elliptical or other similar shape so as to allow the outwardly extending structures 52 to turn through up to 180 degrees as they travel around one end of the track 62, taking a container blank 10 with them. The container blank is eventually disengaged, and the structures 52 revolve around the balance of the track 62 to start the cycle over and bring another container blank 10 around the turn. This overall structure is sometimes referred to herein as a turret.

It is to be appreciated that imparting motion to the arm support structures 52 to cause them to travel along track 62 may be accomplished in a variety of different ways using different mechanical configurations. For example, the arm may be linked to a chain or timing belt, to a direct drive device, a linkage and cam, etc. In the preferred embodiment shown in FIGS. 8-10, a motor 66 such as a servo motor, is provided on the upper surface of plate 60 with its operative shaft engaged with gears inside an adjacent gearbox 67. It is to be appreciated that different sets of gears (not shown) may be provided inside box 67 to modify the speed and strength of the motion imparted by motor 66 according to the requirements of the user. A belt or chain 68 extends from gearbox 67 to an upper sprocket 69 which imparts motion to shaft 70 which, in turn, rotates large lower sprocket 71. Another belt or chain 72 is provided for engagement between sprocket 71 and the base 50 of each of arm support structures 52.

In the illustrated embodiment, each support structure 52 includes one or more followers 53 which engage track 62 allowing structure 52 to travel along this track around and around plate 60. Each support structure 52 also includes a linkage made up of a first pivot 57 attached to one end of rotatable arm 51, a second pivot 58 attached to an inside edge of structure 52, and a linking member 56 connecting between pivots 57 and 58. Second pivot 58 also includes a track follower 59 (not illustrated) which follows an internal track or groove 61 on the underside of base 60. Internal groove 61 follows a path that is inside of and generally parallel to track 62. If groove 61 is parallel to track 62, then the rotation of container blank 10 will be the same as the revolution of support structure 52 around plate 60. However, the rotation of blank 10 may be altered by changing the course of groove 61 which, in turn, will cause arm 51 to rotate as a result of the interaction of pivots 57 and 58 on linking member 56, as described more fully below.

In the illustrated embodiment, container blank 10 is rotated 90 degrees while it revolves 180 degrees around the turn. The following is a description of this particular embodiment, it being appreciated that variations and modifications of such things as the length and curvature of track 62, the relative position of groove 61 in relation to track 62, the size and mounting position of linking member 56, among other things, can be made to impart a specific desired amount of turn and rotation of container blank 10.

The length of groove 61 is shorter than track 62 because it is located inside of track 62. In the illustrated embodiment, groove 61 deviates from an otherwise parallel course with track 62 in two different places. The first such deviation occurs after the first 90 degrees of travel along groove 61 (i.e. during rotation of support structure 52 through 91-180 degrees) following engagement of a container blank 10. The second deviation occurs during the last 90 degrees of rotation of support structure 52 as it completes a circuit around track 62 and prepares to engage another container blank.

The two exemplary deviations along groove 61 cause track follower 59 to cause pivot 58 to move which causes arm 51 to rotate two different times. In the first deviation, the path of groove 61 is changed so as to be closer to track 62. As follower 59 follows this deviation in groove 61, is pushes pivot 58 such that it extends rod 56 outward. This causes pivot 57 to rotate arm 51 in a clockwise direction (as viewed from the top). An opposite deviation is provided later in groove 61 where it travels back away from track 62. This later deviation causes arm 51 to rotate the same amount in the opposite direction.

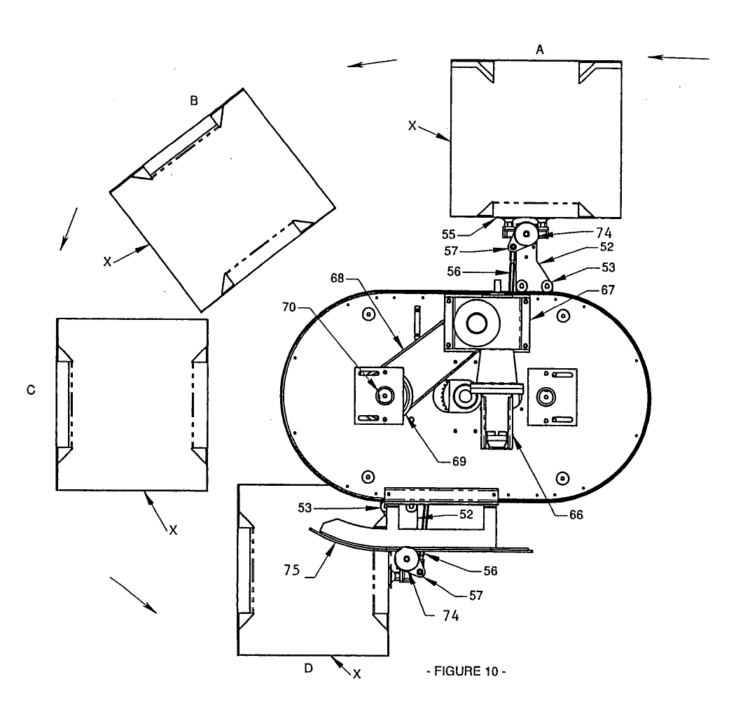

The first of the exemplary deviations in groove 61 has the effect of causing the attached container blank to only rotate 90 degrees while being taken through a turn of 180 degrees. This is illustrated in FIG. 10. First, suction cups 55 temporarily attach to a recently folded container blank 10 as shown in position A. The support structure 52 then follows path 62 in a counter-clockwise direction around plate 60 as shown by positions B and C. At position C, the container blank has traveled through 90 of the 180 degrees of the U-turn around plate 60. At this point (position C), groove 61 begins its deviation from track 62 causing the movement of linkage 56 -57-58 and the clockwise rotation of arm 55. As support structure 52 travels counter-clockwise through the rest of the U-turn (91-180 degrees), arm 55 is rotating clockwise 90 degrees. These countervailing actions have the effect of freezing the rotated position of the container blank 10 while it is brought through the rest of the U-turn, as illustrated in position D, such that the open end X of container blank 10 is only rotated 90 degrees. When the turn is completed, the suction is disengaged releasing blank 10 for further processing. This allows for a mandrel to be conveniently inserted into open end X from the side to facilitate complete formation of the container from the blank.

The second exemplary deviation in groove 61 occurs after the container blank 10 has been released, as support structure 52 travels around the remainder of track 62 prior to picking up the next container blank. In this section of track 62, the path of groove 61 is changed so as to be farther away from track 62. As follower 59 follows this second deviation in groove 61, is rotates pivot 58 such that it pulls rod 56 inward. This causes pivot 57 to rotate arm 51 in a counter-clockwise direction (as viewed from the top), positioning suction cups 55 to pick up the next container blank 10 as support structure 52 begins another lap around track 62.

It is to be appreciated that other embodiments may be employed that have tracks 62 with different curvatures for different sized turns; that have grooves 61 with one or more deviations of varying degrees which result in differing amounts and/or directions of rotation imparted to the support arms 51; and combinations thereof.

In one embodiment of the invention, an additional structure is provided for opening up or raising the body of container blank 10, if desired. In many instances, the container blank that has been formed has more than four side panels (e.g. 6, 8, 10 or 12 panels), but during the initial stages of the formation process, less than all of these panels may yet have been shaped from blank 10 by the time blank 10 reaches the turning apparatus of the present invention. In such situations, it is beneficial to raise the container blank 10 so as to open it up and facilitate the shaping of these additional (often corner) panels. As a result, an embodiment of the present invention provides a mechanism that raises rotatable arm 51 as it travels with support structure 52 along path 60.

In this alternative additional embodiment, each of arms 51 is slidably (as well as rotatably) supported in box 73 of its respective support structure 52. An upper disc 74 is attached to the top of arm 51 above box 73. A tapered guide 75 is provided along path 60 in parallel with track 62 which is engaged by disc 74 as support structure 52 travels along path 60 holding a container blank. Guide 75 has a pointed proximal edge that fits under disc 74 when contact is first made. Guide 75 is shaped so that the edge that fits under disc 74 is angled upward which causes disc 74 (and arm 51) to be raised as disc 74 travels along guide 75. Eventually, the upper edge of guide 75 levels off at a height that is sufficient to raise or open the particular container blank 10 in use. It is to be appreciated that the size of guide 75 and the distance is raises disc 74 may be adjusted according to the requirements of the user and the size of particular container blank 10 in use.

It is to be appreciated that any suitable structure may be used to raise each of slidable arms 51 so as to raise and open container blanks 10. Blanks 10 may also be further opened by the placement of a plow 77 (not shown) along the path of formation that pushes the inside of container out (e.g. down) prior to or after blank 10 is raised by arm 51.

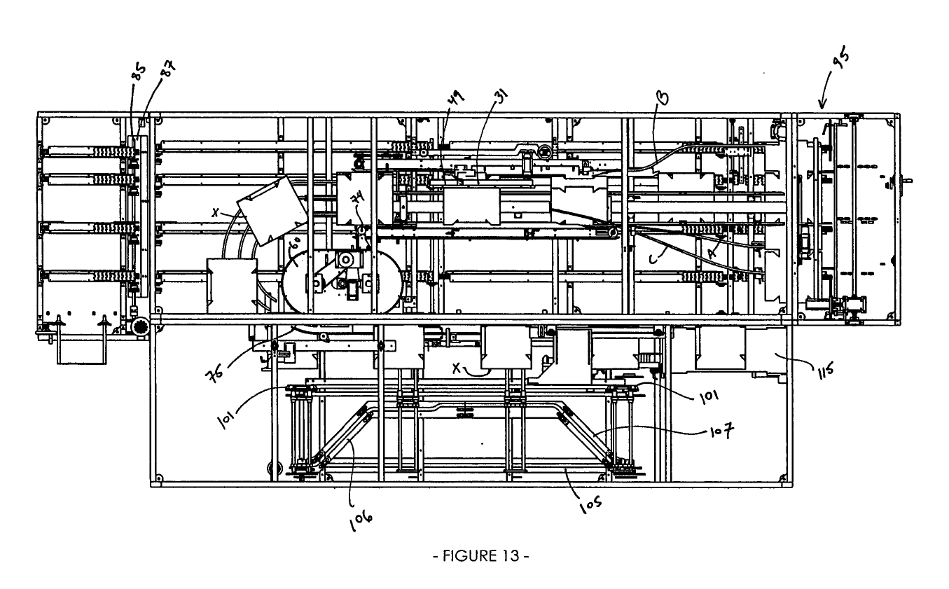

In the illustrated embodiment, the partially-formed container blanks 10 have been rotated only 90 degrees although they have been taken around a 180 degree turn. In this regard, the open ends X of the partially-formed container blanks 10 which were facing “west” as the alignment took place, now face “south” as they enter the final formation section of the machine. See FIGS. 10 and 13. This final formation section includes a set of movable mandrels 101 that are attached to a continuous track 105 so that they revolve around the track. Track 105 is next to and in parallel with the path of formation (now doubled back against itself in the illustrated embodiment) of the partially-formed container blanks 10. As the blanks 10 travel along this section of the path, one of the mandrels 101 is aligned with each blank 10. A set of guides 106 along this section of the path of mandrels 101 causes each mandrel 101 to extend laterally such that it is inserted into a corresponding partially-formed container blank 10 as shown in FIG. 13. Extended mandrels 101 then move along the path with their respective blanks 10 to provide internal bracing and support as panels and flaps on the opposite side of the container blanks 10 are bent and adhered to form the bottom of the container. This formation is performed in a conventional fashion using plows, movable folding elements, adhesive applicators and the like. Another set of guides 107 causes each mandrel 101 to then be removed from each of the now filly formed container blanks 10. The blanks are then conveyed away from the machine on conveyor 115, and the mandrels 101 continue around the track for alignment with another blank 10 to repeat the bottom formation process.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

1. An apparatus for forming multiple-sided containers from flat pre-scored blanks comprising:
a) a plurality of pairs of adjustable pinch rollers for engagement with a dunnage sheet at the bottom of a stack of container blanks for removing said sheet from said stack;
b) at least one first conveyor for moving said stack from said dunnage removal rollers to a lift;
c) a lift for raising said stack;
d) a feeder for moving an uppermost blank from said lifted stack into at least one second conveyor, said second conveyor defining a path of travel for said blank through said apparatus;
e) a plurality of plows deployed along said path for folding said blank as said first conveyor moves it along said path such that a first and last panel of said blank are positioned in a parallel spaced relationship to each other;
f) an adhesive sprayer located along said path downstream from said plows for applying adhesive to one of said first and last panels;
g) a separating bar located along said path downstream from said applicator for holding said first and second panels apart after adhesive has been applied;
h) at least one alignment conveyor located along said path adjacent to said separating bar that engages a trailing panel of said blank;
i) a compression roller located along said path downstream from said separating member and said alignment conveyor for pressing said first and last panels together;
j) a platform having a continuous track around its perimeter located on said path downstream from said compression roller;
k) at least one support structure movably engaged with said track for traveling thereon;
l) a rotatable arm pivotally attached to each support structure, each such arm supporting at least one variably operable vacuum attachment device for temporary engagement with said blank;
m) a continuous groove on said platform in the vicinity of said track;
n) a movable linkage on said support structure, a first end of said linkage being pivotally attached to said arm, and an opposite end of said linkage being attached to a follower that fits into said groove wherein said linkage is capable of imparting rotation to said arm in response to the movement of said follower in said groove as said support structure travels along a section of said track;
o) a plurality of movable mandrels attached to a second continuous track located at the end of said section of said first track wherein each of said mandrels aligns with a corresponding container blank and is temporarily inserted therein;
p) a plurality of folding elements and adhesive applicators for forming the bottom portion of said container while each such mandrel is inserted into a blank; and
q) a conveyor for removing formed containers from said machine.

2. The apparatus of claim 1 wherein said rotatable arm is also slidably attached to said support structure allowing for reciprocating vertical movement, a second follower is attached to said arm, and a guide is provided along a section of said track for engagement with said second follower to raise and lower said arm as said support structure travels along said guide.

3. The apparatus of claim 1 wherein said alignment conveyor is at least one continuous belt with a plurality of adjustably positionable cleats located thereon for engagement with a trailing edge of a panel of said blank, said belt being attached to a motor that is capable of changing speeds to quickly catch up with said first conveyor and thereafter match the speed of said first conveyor.

4. A method for forming multiple-sided containers from flat blanks comprising the steps of:
a) removing a dunnage sheet from the bottom of a stack of said blanks;
b) moving said stack onto a lifting device;
c) lifting said stack;
d) feeding the uppermost blank of said lifted stack into a conveyor defining a formation path through a machine;
e) folding said blank using a plurality of plows deployed along said path such that a first and last panel of said blank are positioned in a parallel spaced relationship to each other;
f) applying adhesive to one of said first and last panels;
g) keeping said first and last panels separated from each other after said adhesive has been applied and while alignment is taking place;
h) engaging a trailing panel of said blank using an alignment conveyor located along said path to bring said trailing panel into alignment with the other panels of said blank while maintaining separation between said first and last panels; and
i) compressing said first and last panels together after alignment has been accomplished.

5. The method of claim 4 comprising the additional steps of:
j) temporarily engaging said blank with at least one vacuum suction device, said suction device being attached to a support shaft, said shaft being attached to a support structure that travels along a continuous track;
k) moving said support structure such that said temporarily attached blank travels along a section of said track; and
l) disengaging said suction device from said blank at the end of said section of track.

6. The method of claim 5 wherein a groove is provided in the vicinity of said track, a moveable follower is provided in said groove, said support shaft is rotatable, and a movable linkage is provided between said follower and said support arm.

7. The method of claim 6 comprising the additional step of:
m) rotating said shaft in response to the movement of said follower in said groove as said support structure travels along said track.

8. The method of claim 7 wherein said rotatable shaft is also slidably attached to said support structure allowing for reciprocating vertical movement, a second follower is attached to the top of said shaft, and a guide is provided along a section of said track for engagement with said second follower.

9. The method of claim 8 comprising the additional step of:
n) raising and lowering said arm as said support structure travels along said guide.

10. The method of claim 9 wherein said guide is provided within the same section of said track where said vacuum suction means temporarily attaches to said container.

11. The method of claim 5 comprising the additional steps of:
m) temporarily inserting a moveable mandrel into said blank as it travels along a new path following disengagement from said suction device;
n) folding and adhering panels to form the bottom of said blank;
o) removing said mandrel from said blank; and
p) discharging said blank from said machine.

12. The method of claim 9 comprising the additional steps of:
o) temporarily inserting a moveable mandrel into said blank as it travels along a new path following disengagement from said suction device;
p) folding and adhering panels to form the bottom of said blank;
q) removing said mandrel from said blank; and
r) discharging said blank from said machine.

13. A method for forming multiple-sided containers from flat blanks comprising the steps of:
a) feeding the uppermost blank of a stack into a conveyor defining a formation path through a machine;
b) folding said blank using a plurality of plows deployed along said path such that a first and last panel of said blank are positioned in a parallel spaced relationship to each other;
c) applying adhesive to one of said first and last panels;
d) keeping said first and last panels separated from each other after said adhesive has been applied and while alignment is taking place;
e) engaging a trailing panel of said blank using an alignment conveyor located along said path to bring said trailing panel into alignment with the other panels of said blank while maintaining separation between said first and last panels;
f) compressing said first and last panels together after alignment has been accomplished;
g) temporarily engaging said blank with at least one vacuum suction device, said suction device being attached to a support shaft, said shaft being attached to a support structure that travels along a continuous track;
h) moving said support structure such that said temporarily attached blank travels along a section of said track; and
i) disengaging said suction device from said blank at the end of said section of track.

14. The method of claim 13 comprising the additional steps of:
j) temporarily inserting a moveable mandrel into said blank as it travels along a new path following disengagement from said suction device;
k) folding and adhering panels to form the bottom of said blank;
l) removing said mandrel from said blank; and
m) discharging said blank from said machine.

15. An apparatus for forming multiple-sided containers from flat pre-scored blanks comprising:
a) a dunnage removal means for removing the bottom sheet of a stack of container blanks;
b) at least one first conveying means for moving said stack from said dunnage removal rollers to a lift;
c) a lift means for raising said stack;
d) a feeder means for moving an uppermost blank from said lifted stack into at least one second conveyor means, said second conveyor means defining a path of travel for said blank through said apparatus;
e) plow means deployed along said path for folding said blank as said first conveyor moves it along said path such that a first and last panel of said blank are positioned in a parallel spaced relationship to each other;
f) an adhesive application means located along said path downstream from said plows for applying adhesive to one of said first and last panels;
g) a separating means located along said path downstream from said application means for holding said first and second panels apart after adhesive has been applied;
h) at least one alignment means located along said path adjacent to said separating means that engages a trailing panel of said blank;
i) a compression means located along said path downstream from said separating means and said alignment means for pressing said first and last panels together;
j) platform means having a continuous track around its perimeter located on said path downstream from said compression means;
k) at least one support means movably engaged with said track for traveling thereon;
l) a rotatable arm means pivotally attached to each support means, each such arm means supporting at least one variably operable vacuum attachment means for temporary engagement with said blank;
m) groove means on said platform in the vicinity of said track;
n) movable linkage means on said support means, a first end of said linkage being pivotally attached to said arm means, and an opposite end of said linkage being attached to a following means that fits into said groove means wherein said linkage is capable of imparting rotation to said arm means in response to the movement of said following means in said groove means as said support means travels along a section of said track;
o) a plurality of movable mandrel means attached to a second continuous track located at the end of said section of said first track wherein each of said mandrel means aligns with a corresponding container blank and is temporarily inserted therein;
p) a plurality of folding means and adhesive application means for forming the bottom portion of said container while each such mandrel means is inserted into a blank; and
q) a third conveying means for removing formed containers from said machine.
